(19) United States
(12) Patent Application Publication
(10) Pub. No.: US 2013/0151429 A1
(43) Pub. Date: Jun. 13, 2013

(54) SYSTEM AND METHOD OF DETERMINING ENTERPRISE SOCIAL NETWORK USAGE

(71) Applicants: Jin CAO, Edison, NJ (US); Li Erran LI, Edison, NJ (US); Hongyu GAO, Evanston, IL (US); Brian D. FRIEDMAN, Basking Ridge, NJ (US)

(72) Inventors: Jin CAO, Edison, NJ (US); Li Erran LI, Edison, NJ (US); Hongyu GAO, Evanston, IL (US); Brian D. FRIEDMAN, Basking Ridge, NJ (US)

(21) Appl. No.: 13/688,885

(22) Filed: Nov. 29, 2012

Related U.S. Application Data
(60) Provisional application No. 61/565,093, filed on Nov. 30, 2011.

(51) Int. Cl. G06Q 50/00

(52) U.S. Cl. CPC G06Q 50/01; G06Q 10/105
USPC 705/319

(57) ABSTRACT

According to an embodiment, a computing system includes at least one computing device including a processor configured to use a logistic regression model to provide an indication of a relationship between a user's position within an enterprise and how the user interacts with other users of an enterprise social network.

### CROSS-REFERENCE TO RELATED APPLICATION

This application claims priority to U.S. Provisional Patent Application Ser. No. 61/565,093 which was filed on Nov. 30, 2011.

### BACKGROUND

Social networks have become extremely popular. The way in which many people communicate has been changed by their use of social networks. The significant impact that such networks have had on the ability for individuals to communicate with each other has given rise to interest in implementing similar networks into a corporate or organizational environment. An enterprise social network may, for example, enhance the ability of various employees or key players to interact more efficiently. Some forms of enterprise social network may make other technology-dependent communications, such as email and instant messaging, seem cumbersome or outdated. Further, enterprise social networks may enhance communications among users who are accustomed to communications outside of work through a social network.

While enterprise social networks may present benefits, it is difficult to understand whether the overall effect will be positive. If, for example, the enterprise social network is not used for interactions that are considered significant to advancing the goals of the organization, then the net effect may not be positive. The way in which an enterprise network enhances or detracts from the function of the organization will depend, in part, on the manner in which individuals utilize the enterprise social network.

### SUMMARY

According to an example embodiment, a computing system includes at least one computing device including a processor configured to use a logistic regression model to provide an indication of a relationship between a user's position within an enterprise and how the user interacts with other users of an enterprise social network.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a computing system configured to provide information regarding use of an enterprise social network.

FIG. 2 is a flow chart diagram summarizing an example technique for obtaining information regarding how an individual's position in an enterprise has an effect on the use of an enterprise social network.

### DETAILED DESCRIPTION

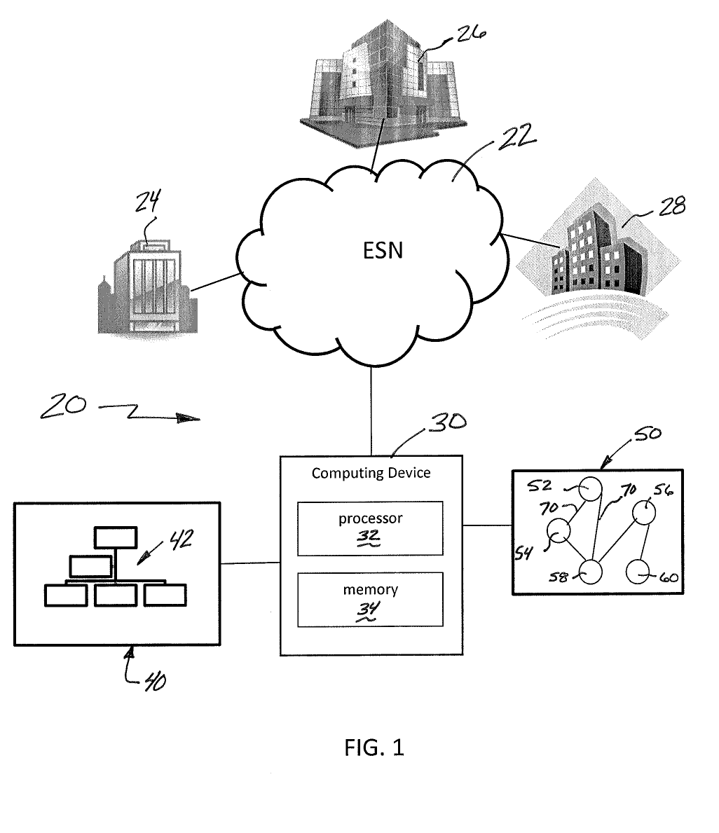

FIG. 1 schematically shows selected portions of a computing system 20 that is configured to provide information regarding use of an enterprise social network (ESN) 22. In the illustrated example, an enterprise (e.g., a corporation, government or organization) has several facilities 24, 26 and 28 that are geographically remote from each other. In some examples at least one of the facilities 24-28 will be located in a different country than another one of the facilities. The ESN 22 is useful in this example to allow individuals associated with the enterprise to communicate with each other. Example ways of communicating using the ESN 22 include those that are currently in use over known social networks.

At least one computing device 30 is configured to provide information regarding how the hierarchical or organizational position of an individual within the enterprise or organization has an effect on one or more aspects of use of the ESN 22. This example embodiment of the computing device 30 is configured to quantify the effect of a user's position in the organization on social interactions using the ESN 22 through formal statistical modeling. A processor portion 32 is configured to execute a set of instructions programmed into or provided to a memory portion 34 to perform the formal statistical modeling.

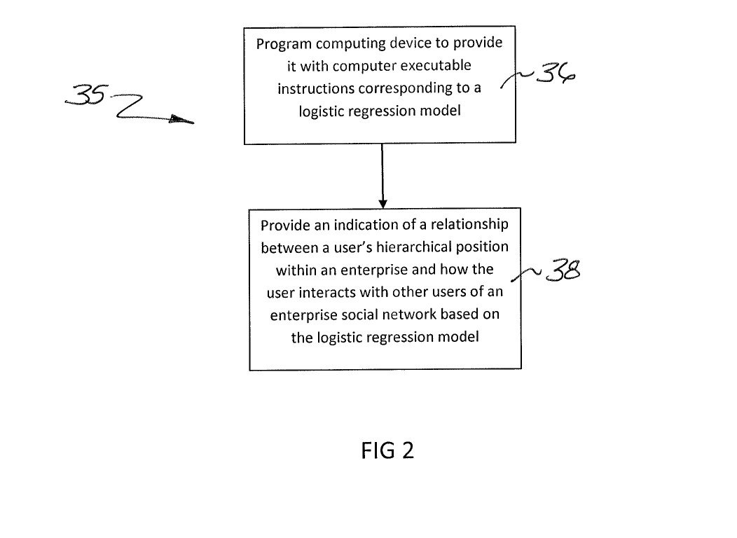

FIG. 2 includes a flowchart 35 that summarizes an example approach taken in one example embodiment. At 36, the computing device 30 is provided with computer executable instructions corresponding to a logistic regression model, for example by programming and storing the instructions in the memory portion 34. The processor 32 is configured to execute the logistic regression model. At 38, the computing device provides an indication of a relationship between a user's hierarchical position within an enterprise and how the user interacts with other users of an enterprise social network based on the logistic regression model.

The computing device 30 in some examples is a part of the ESN 22 (e.g., part of a server or other computing device used to provide or facilitate the ESN 22). In other examples, the computing device 30 is distinct from the ESN 22 but communicates with one or more portions of the ESN 22 to obtain information that is useful for the computing device 30.

This embodiment includes considering an enterprise organizational graph 40, which indicates a hierarchical arrangement 42 of individuals within the organization, and a user interaction graph 50. In this example, the users of the ESN 22 are represented as nodes 52-60 and interactions between users are represented as edges 70. The illustrated example includes using a known way of developing a social network interaction graph as schematically shown at 50.

The following description includes treating the user interaction graph as an undirected graph. More specifically, nodes (i.e., individual users or employees) 52-60 are considered as connected by an undirected edge 70 if there is a directed edge between them in either direction. An edge 70 between nodes corresponds to an interaction between the corresponding individuals using the ESN 22. Although possible with other implementations of the disclosed embodiment, the following description does not include any consideration of the weight of the edges, which represents the number of interactions between the same users.

The interaction graph 50 changes more often than the organization graph 40 and the latter is considered constant for purpose of describing an example embodiment. Modeling the interaction graph 50 (with a static organizational graph 40) can be accomplished using a selected amount of interaction data over a selected period of time.

This example embodiment includes modeling the user interaction graph 50 as a random graph, meaning that it is generated by a random process. The edges 70 in the user interaction graph 50 are modeled as Bernoulli random variables, which take a value of 0 or 1 with a certain probability value. Letting N represent the total number of users, for any two users (i, j), i, j=1, . . . , N, i≠j, Yᵢⱼ can be the indicator variable of the presence of an interaction between the user pair. Then Yᵢⱼ is modeled as a Bernoulli random variable with probability pᵢⱼ. This can be represented using the following equation:

P(Yᵢⱼ)=pᵢⱼ^{Yij}(1−pᵢⱼ)^{(1-Yij)} (2)

This example includes the further simplifying assumption that Yᵢⱼ, i, j=1, . . . , N can be treated as independent random variables. Under circumstance in which pᵢⱼ are all equal (independent of i, j), this is the well-known Erdös-Rényi model in graph theory. In contrast to constant pᵢⱼ, this example embodiment includes modeling how pᵢⱼ, the propensity of a connection between two users, is affected by their mutual relationship in the corporate hierarchy.

For the users (i, j), let Xᵢⱼ be a set of covariates derived from their relationship in the organization graph 40. Furthermore, let Zᵢⱼ be a set of exogenous covariates that might be of importance for modeling interactions. This example includes developing a statistical model of Yᵢⱼ by expressing pᵢⱼ as a function of these covariates. The computing device 20, in one example, models the dependency of pᵢⱼ on Xᵢⱼ and Zᵢⱼ using at least one well-known logistic regression model, several of which are available from statistical literature, using the following relationship.

$$log it ( {p}_{ij} ) = log \frac{{p}_{ij}}{1 - {p}_{ij}} = μ + {α}^{T} {Z}_{ij} + {β}^{T} {X}_{ij} , \qquad ( 3 )$$

where μ, α, β are vectors of unknown parameters that need to be estimated from the interaction data and ^{T} stands for transpose. Since the Xᵢⱼ are covariates related to the organization graph 50, the computing device 30 in this example is configured to quantify β.

Under the logistic regression model of equation (3) and independence assumption, the log-likelihood of observed data is

$$Log \text{-} likelihood = {\sum }_{i , j} ( {Y}_{ij} log {p}_{ij} + ( 1 - {Y}_{ij} ) log ( 1 - {p}_{ij} ) ) \qquad ( 4 )$$

where pᵢⱼ is given in equation (3), and the summation is taken over all combinations of two users i, j. This example includes letting P be the number of free parameters in the logistic regression model, and U be the total number of user sets, then the degree of freedom of the logistic regression model is L=U−P. It is well known that when the regression model is the true model and when U is large, asymptotically, the deviance score can be defined as

Deviance=−2(Log−likelihood) (5)

where Log−likelihood is defined in equation (4) as X² distributed with L degrees of freedom. Furthermore, the difference in the deviance score in two nested models is also X² distributed. Thus the deviance scores can be used for measuring goodness of fit of certain models, for model selection and for significance tests.

Another feature of this example is that it includes the well-developed iterative re-weighted least squares developed for generalized linear models to estimate the unknown parameters in the logistic regression model. One implementation accomplishes this using the known glm routine in statistical language R.

As those skilled in the art may appreciate, the example statistical modeling methodology for user interaction graphs, which uses logistic regression models, is closely related to the exponential random graph models (or p* models) proposed in the literature. In the framework of exponential random graphs, the joint distribution of linkages between nodes is modeled using local graph configurations. Dependence in linkages can be accommodated by considering complex local configurations such as two-star, three-star or triangle arrangements. Two methods have been developed to optimize the model parameters: Markov Monte Carlo maximum likelihood estimation and pseudo-likelihood estimation as an approximation technique. It has been shown that for large graphs, the two methods give estimates that do not differ significantly. The logistic regression model of this example embodiment is similar to the logistic regression approximations for the exponential random graphs under the simplifying assumption that edges are independent. The independence constraint can be relaxed in some implementations if desired by borrowing ideas from the framework of exponential random graph models.

One feature of the example embodiment is that the model has a much simpler form than the usual logistic regression approximation model in an exponential random graph framework. To account for individual node level effects on interactions, the logistic regression approximation will have to use one covariate per node, thus creating a large set of covariates for a large network of many nodes. This significantly increases the difficulty for model fitting. In contrast, the example embodiment of this description eliminates this difficulty by using the observed node degrees as substitutes for node level activity, and treats the joint activity level as a single covariate in modeling the interactions.

This example includes covariates in the logistic regression model (i.e., equation (3)). The exogenous covariates represented by Zᵢⱼ account for the fact that each user has a different activity level that may impact that user's interactions with other users. Furthermore, a user's level of interaction with others differs widely among users. It is useful to include this effect in the model and differentiate it from the more significant effects derived from organization graph.

Given the user population, for user i, let aᵢ be the total number of interactions with other users in the population, (i.e., user i's degree in the interaction graph). Analysis of aᵢ for the interaction graph reveals that aᵢ follows a heavy-tailed distribution. For several heavy users, the number of interactions can reach up to 200, while around 90 percent of other users may have less than 10 interactions.

Assume that a user interacts with other users independently given his/her activity level aᵢ. As user population gets large, it is easily derived from random graph theory that the probability that the user pair (i, j) has an interaction is proportional to aᵢaⱼ. The statistical models of this example embodiment include this pure chance activity effect as an exogenous covariate. In the event that the interaction graph is very sparse, pᵢⱼ are typically small and, under the logistic regression model of equation (3), it is reasonable to use log(aᵢaⱼ) as an exogenous covariate to represent their level of interaction by chance alone. Other exogenous covariates that might be important for modeling could be age, race and gender, but those are not considered in this description.

Several covariates Xᵢⱼ are derived from the organization graph to characterize user relationships in the corporate hierarchy. For user i, let cᵢ be the country where he is from. For two users (i, j) the indicator variable I(cᵢ=cⱼ) is a suitable covariate representing whether or not users from the same country are more likely be linked. Using K as a set of possible countries, a more expansive form for characterizing how users are geographically alike are the set of indicator variables I(cᵢ=k, cⱼ=l), k=1, . . . K which identifies their country pair.

For two users (i, j) we extracted covariates related to their relative positions in the organization graph. The first candidate is the company hierarchy distance dᵢⱼ, which is defined as the number of hops to their nearest common ancestor (on the organizational chart). In the event that the two users have a different number of hops to that common ancestor, the larger number is selected as dᵢⱼ. For example, a distance l would imply either a boss/subordinate or a co-worker relationship. Since the hierarchical distance does not necessarily fully capture the relative position of the users in the organization graph, this example embodiment includes additional covariates. For this purpose, a level-1 organization is an organization of employees with a common ancestor at level 1. For example, a level-1 organization includes all employees under the same person who is a direct subordinate under the CEO. Given that most employees are at level 5 in the hierarchy, for this example, the maximum level of organizations considered for discussion purposes is 3. The set of indicator variables Orgᵢⱼ(l), l=1, 2, 3 are considered as covariates in this example.

For discussion purposes and to limit the scale of the interaction data, only users having 5 or more interactions during a considered time period are included in the analysis. In this example, the size of the vector Yᵢⱼ is N (N−1) where N is the number of users so that reducing the number of users under consideration simplifies the analysis. In this example, the user's country location is also considered and the number of countries under consideration in this discussion can be assumed to be limited to those countries in which the most interactions occur (e.g., 10 countries). For discussion purposes, consider interaction data based on a total of 1284 ESN users, which results in a vector of Yᵢⱼ for all pairs of length 823686. Typical of a network graph, the value of Yᵢⱼ is mostly 0 except for about 4000 entries.

Let

rᵢⱼ=log(aᵢaⱼ), (6)

where aᵢ, aⱼ are node degrees (number of interacting users) for i, j respectively. In the following, four sets of statistical models are used for analysis. First consider the basic model:

M_{b}: logit(pᵢⱼ)=μ+αrᵢⱼ (7)

Using cᵢ to represent the counter of user i, a second set of models incorporate user geo-location (country) as covariates:

$$\{ \begin{matrix}{M}_{c 1} \text{:} log it ( {p}_{ij} ) = μ + α {r}_{ij} + β I ( {c}_{i} = {c}_{j} ) \\ {M}_{c 2} \text{:} log it ( {p}_{ij} ) = μ + α {r}_{ij} + {{\sum }_{k , l = 1}}^{10} {β}_{kl} I ( {c}_{i} = k , {c}_{j} = l )\end{matrix} \qquad ( 8 )$$

where μ, α, β, βₖₗ are unknown parameters with β representing the relative preference of two users from the same country to interact (e.g., be linked together on the interaction graph) and βₖₗ representing the relative preference of a user from a country k to be linked to a user from a country l. The value 10 is used as the upper limit in the summations because the top 10 countries are included in the described embodiment. It is easy to see that M_{c2} is an expanded model of M_{c1}, as it not only considers whether the users are from the same country, but also the distinct country pairs. As will be appreciated by those skilled in the art who have the benefit of this description, it may be useful to study if adding this extra complexity is useful for predicting interactions using the ESN.

For two users (i, j), dᵢⱼ represents their corporate hierarchy distance and Orgᵢⱼ(l), l=1, 2, 3 represents whether the users are from the same level-1 organization. The third set of statistic models incorporate covariates that characterize the relative positions in corporate hierarchy. Ordered in increasing level of complexity, they are:

$$\{ \begin{matrix}{M}_{h 1} \text{:} log it ( {p}_{ij} ) = μ + α {r}_{ij} + {{\sum }_{k = 1}}^{10} {γ}_{k} I ( {d}_{ij} = k ) \\ {M}_{h 2} \text{:} log it ( {p}_{ij} ) = μ + α {r}_{ij} + {{\sum }_{k = 1}}^{10} {γ}_{k} I ( {d}_{ij} = k ) + {{\sum }_{l = 1}}^{3} {η}_{l} {Org}_{ij} ( l ) ,\end{matrix} \qquad ( 9 )$$

where μ, α, γk, ηι are the unknown parameters with γk represents the relative preference of a user pair with hierarchy distance of k to be linked together, and ηι represents the preference of a user pair being in the same level-1 organization to be linked together. The effect of Orgᵢⱼ(1), Orgᵢⱼ(2) and Orgᵢⱼ(3) are nested in this example.

Finally, the full model that incorporates both covariates from user countries and their positions in the company hierarchy is represented by:

M_{f}: logit(pᵢⱼ)=μ+αrᵢⱼ+Σ_{k, l=1}¹⁰βₖₗI(cᵢ=k, cⱼ=l)+Σₖ₌₁¹⁰γₖₗI(dᵢⱼ=k)+Σₗ₌₁³ηιOrgᵢⱼ(l) (10)

The fitted unknown parameters with respect to company hierarchy and geo-location are useful in this example because they quantify the magnitude of effects. Interestingly, the fitted parameters of geo-location covariates and hierarchy level covariates remain relatively stable in examples that include more restrictive or more expanded models. Fitted parameters for different models, respectively, indicate that a random model between two users conditioning on their level of activity is a good base model.

To interpret the effect of corporate hierarchy related co-variants, it is useful to consider a scenario in which one model uses a different country as the baseline and another model uses the hierarchy distance of 1 as the baseline. Since the fitted probability vales pᵢⱼ are small compared to 1 and the model fits are done at the logit scale, if two users are from the same country, then they are e^{0.82}=2.27 times more likely to interact than if they are from different countries, based on sample use data.

Similarly, users are more likely to interact if their hierarchy distance is small. For example, based on sample use data, if the distance between two users is 2, then they are e^{1.35}=3.85 times less likely to interact than if the distance between them is 1, which indicates a peer-to-peer or boss-to-subordinate relationship. Similarly, if the distance between two users is 3, then they are e^{3.18}=24 times less likely to interact than if the distance between them is 1. Testing using an example embodiment indicates that there are not significant differences in preferences to interact when the hierarchy distance is equal to or larger than 5, which is because the company hierarchy is not a tree of equal depth in every branch. Many leaf nodes are distributed in level 5 and lower levels. As a result, many user sets with a hierarchy distance equal to or larger than 5 are the users that are farthest away from each other in the company hierarchy, which may indicate that their nearest common ancestor in the company hierarchy tree is the root (e.g., the company CEO).

According to this example, ESN users are more likely to interact with other users from the same country and closer in corporate hierarchy. This does not contradict a theory that ESN's may bring users from diverse locations and social status together. This is because the number of users adjacent to a particular user in the organization graph is small comparing to the number of users that are far apart. So for users that are far apart, even though the probability of them interacting may be small, it is possible to observe many occurrences of such interactions.

To provide further context for interpreting the results of the example modeling technique, it should be noted that, except for the CEO and a few other high-ranking company employees that are well-known throughout the company, a given ESN user in an enterprise environment probably does not know the “rank” of another unfamiliar user outside of their organization. So although there already seems to be less interaction between users that are far apart in hierarchy, the fact that a given user may not know the rank of the person they are contemplating communicating with may have a “hidden” effect. The same is true for the country information. Although results provided by the computing device 20 may suggest that users do communicate across country boundaries (albeit typically at a lower rate than within the same country), there may be some “hidden” effect on such communications since a given user may not know where another user is from. It is also worth noting that it likely is much easier for an individual to determine the country location of another individual while determining their hierarchical relationship to other users would likely require more effort on the part of the user seeking such information. For example, an ESN user profile is likely to indicate the country where that individual is located, but some other corporate database would likely be needed to make a determination regarding the hierarchy position of a particular individual.

One example includes determining whether any particular covariates have a significant impact on the ESN usage modeling. One example includes using the well-known statistical hypothesis testing procedure to test the overall significance of certain groups of covariates such as country and hierarchy distance. Take the country models of equation (8) as an example. To see if the addition of “country pairs” is significant on top of the effect of “same country,” it is possible to test the following hypothesis:

H₀: β_{k, l}=0, for all, k, l=1, . . . , 10.

against

H₁: at least one β_{k, l}≠0, k, l=1, . . . , 10.

To achieve this, let L_{c1}, L_{c2} be the degrees of freedom under the two models respectively (in this instance, L_{c1}=U−3, L_{c2}=U−56, where U is the total number of user pairs). Let D_{c1}, D_{c2} be the respective deviance scores of the two fitted models of equation (5). Then compare the values of D_{c1}−D_{c2} with a X² distribution with L_{c2}−L_{c1} degrees of freedom. If the p-value associated with the X² distribution is small, then reject the null hypothesis (i.e., the effect is significant).

One embodiment includes fitting all models (7), (8), (9), (10) using the known generalized linear model routine in the statistical software R. That makes it possible to consider the deviance of the fitted models with their respective degrees of freedom. To see whether the geographic locations and corporate hierarchy covariates are significant, it is possible to use the X² significance test mentioned above. According to sample data, all organization graph-related effects are highly significant. In particular, the addition of hierarchical level covariates yields a bigger reduction in the deviance score than the geo-location covariates, indicating the more important role of corporate hierarchy in predicting user interactions and, therefore, likely ESN usage. Also interestingly, a covariate corresponding to whether users are within a selected portion of the organization provides significant additional improvement over models using hierarchical distance alone.

As the ESN medium bring users from diverse locations and social status together, it becomes possible to consider interacting users as forming ad-hoc communities. On example embodiment includes considering such user communities as potential covariates for modeling the user interactions. One example includes determining user communities based on the leading eigenvectors of an adjacency matrix.

For example, let gᵢ be the community of user i. It is possible to consider the following two models.

M_{com}: logit(pᵢⱼ)=μ+αrᵢⱼ+Σ_{k, l=1}⁷φₖₗI(gᵢ=k, gⱼ=l)

M_{f+com}: logit(Pᵢⱼ)=μ+αrᵢⱼ+Σ_{k, l=1}¹⁰βₖₗI(cᵢ=k, cⱼ=l)+ΣₖγₖI(dᵢⱼ=k)+Σₗ₌₁ηιOrgᵢⱼ(l)+Σ_{k, l=1}⁷φₖₗI(gᵢ=k, gⱼ=1) (11)

where M_{com} is the model with community covariates alone, and M_{f+com} is the complete model with both corporate hierarchy related covariates and community covariates.

From sample use data, it is apparent that the effect of the community is significant and provides additional improvement to the overall fit. Comparing M_{f} and M_{f+com}, the difference in deviance in one example is 1699, while the reference value of a X² distribution with 48 degrees of freedom is only 73.7. It is also interesting to observe that the community covariates alone are not sufficient to substitute them for the corporate hierarchy related effects, since M_{com} has a much higher deviance score than M_{f}. In this example, the effect introduced by communities is almost orthogonal to that of organization graph covariates. Additionally, it is worth noting that the fitted parameters for the organization graph covariates are almost unchanged when including the community covariates.

As can be appreciated from the preceding description, the computing device 20 is configured to use the described formal statistical models to quantify the effect of a user's attributes from the organization graph on their interaction patterns in the enterprise social network. The above-described models are based on logistic regression, and are related to but not identical to the exponential random graph models (or p* models) proposed in the literature. The described example embodiment shows that a user's geo-location and position in a corporate hierarchy are highly significant in predicting that user's interactions on the ESN. For example, in one scenario if two users are from the same country, then they are 2.27 times more likely to interact than if they are from different countries. Furthermore, users are more likely to interact if their hierarchy distance (on the organizational graph) is small. As another example, if the hierarchical distance between two users is 2, than they are 3.85 times less likely to interact than if that distance is 1, which indicates a peer-to-peer or boss-to-subordinate relationship. Finally, as the enterprise social network medium brings together users from diverse locations and social status they will tend to form ad-hoc communities. The above-described example accounts for such communities in the statistic models, which improves the fit significantly.

The described example approach may be used for obtaining ESN interaction information that is useful for designing or modifying ESNs. For example, the features of an ESN provided to a user may be customized based on that user's position within the organization to facilitate more efficient use of computing resources to serve the expected needs of that user. Additional features may be added to facilitate easier use of features that are most likely to be used in expected interactions involving particular users. Different ESN interface configurations may be provided to individuals at different levels within the hierarchical structure of the organization to more readily facilitate their use of the ESN.

The preceding description is illustrative rather than limiting in nature. Variations and modifications to the disclosed example may become apparent to those skilled in the art. The scope of legal protection can only be determined by studying the following claims.

We claim:

1. A computing system, comprising:
at least one computing device including a processor configured to use a logistic regression model to provide an indication of a relationship between a user's position within an enterprise and how the user interacts with other users of an enterprise social network.

2. The computing system of claim 1, wherein the computing device is configured to use the logistic regression model to provide an indication corresponding to a quantified effect of the user's position within the enterprise relative to other users on the user's interactions through the enterprise social network.

3. The computing system of claim 1, wherein the computing device is configured to include as inputs
information regarding an enterprise organizational graph which indicates a hierarchical arrangement of individuals within the enterprise and
information regarding a user interaction graph which indicates at least one interaction between at least two users of the enterprise social network.

4. The computing system of claim 3, wherein the user interaction graph includes
a first node to represent the user;
a second node to represent another user of the enterprise social network; and
and an edge between the first and second nodes to represent at least one interaction between the represented users.

5. The computing system of claim 4, wherein the computing device is configured to treat the user interaction graph as an undirected graph.

6. The computing system of claim 3, wherein the user interaction graph is based on a selected amount of interaction data over a selected period of time.

7. The computing system of claim 3, wherein the user interaction graph comprises a random graph generated by a random process.

8. The computing system of claim 1, wherein the computing device is configured to model how a propensity of a connection between two users is affected by their mutual relationship in the enterprise hierarchy.

9. The computing system of claim 1, wherein the computing device is configured to use a statistical model that includes an indicator variable of a presence of an interaction between two users of the enterprise social network, the indicator variable being based on a probability of the interaction and wherein the probability is expressed as a function of at least one covariate derived from a hierarchical relationship between the users.

10. The computing system of claim 9, wherein the computing device is configured to use a logistic regression model, expressed as
$$log it ( {p}_{ij )} = log \frac{{p}_{ij}}{1 - {p}_{ij}} = μ + {α}^{T} {Z}_{ij} + {β}^{T} {X}_{ij} ,$$
wherein μ, α, β are vectors estimated from interaction data corresponding to use of the enterprise social network, ^{T} stands for transpose, Xᵢⱼ are covariates related to an organization graph indicating the hierarchical relationship, and Zᵢⱼ are exogenous covariates.

11. A method of analyzing use of an enterprise social network, comprising the steps of:
providing computer executable instructions corresponding to a logistic regression model to at least one computing device including a processor configured to execute the instructions; and
using the at least one computing device to provide an indication of a relationship between a user's hierarchical position within an enterprise and how the user interacts with other users of an enterprise social network based on the logistic regression model.

12. The method of claim 11, comprising using the logistic regression model to provide an indication corresponding to a quantified effect of the user's position within the enterprise relative to other users on the user's interactions through the enterprise social network.

13. The method of claim 12, comprising using
information regarding an enterprise organizational graph which indicates a hierarchical arrangement of individuals within the enterprise and
information regarding a user interaction graph which indicates at least one interaction between at least two users of the enterprise social network
as inputs for the logistic regression model.

14. The method of claim 13, wherein the user interaction graph is based on a selected amount of interaction data over a selected period of time.

15. The method of claim 13, wherein the user interaction graph comprises a random graph generated by a random process.

16. The method of claim 11, comprising modeling how a propensity of a connection between two users is affected by their mutual relationship in the enterprise hierarchy.

17. The method of claim 11, comprising using a statistical model that includes an indicator variable of a presence of an interaction between two users of the enterprise social network, the indicator variable being based on a probability of the interaction and wherein the probability is expressed as a function of at least one covariate derived from a hierarchical relationship between the users.

18. The method of claim 17, comprising using a logistic regression model, expressed as
$$log it ( {p}_{ij )} = log \frac{{p}_{ij}}{1 - {p}_{ij}} = μ + {α}^{T} {Z}_{ij} + {β}^{T} {X}_{ij} ,$$
wherein μ, α, β are vectors estimated from interaction data corresponding to use of the enterprise social network, ^{T} stands for transpose, Xᵢⱼ are covariates related to an organization graph indicating the hierarchical relationship, and Zᵢⱼ are exogenous covariates.
